(19) United States
(12) Patent Application Publication
(10) Pub. No.: US 2006/0150228 A1
(43) Pub. Date: Jul. 6, 2006

(54) Method and system for linking legacy dvd discs to related web sites

(76) Inventors: Declan Patrick Kelly, Shanghai (CN); Bei Wang, Shanghai (CN); Yang Peng, Shanghai (CN); Dahua He, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/535,637

(22) PCT Filed: Nov. 27, 2003
(86) PCT No.: PCT/IB03/05285

§ 371 Date: Nov. 23, 2005

(30) Foreign Application Priority Data
Nov. 22, 2002 (CN) 02152299.5

(51) Int. Cl. H04N 7/173

(52) U.S. Cl. 725/109; 725/112; 725/113

(57) ABSTRACT

The present invention provides a WebDVD player to link legacy DVD discs to related web sites and to play normal WebDVD discs. The player includes a database containing a URL list of popular DVD content providers. After the disc is loaded into the player, the player reads the provider unique identification (PVR ID) and uses the PVR ID to find URL of associated content provider from URL list. URL of content provider is indexed to a table containing a list of some popular title identifications (Title IDs) of discs, location of Title ID on the disc, method of deriving Title ID, and URL of a related web site. The player then attempts to derive the Title ID of the disc according to the method in the table and compares the derived Title ID with the data in the Title ID column of the table to find the corresponding URL for locating the web pages of the content provider.

### BACKGROUND OF THE INVENTION

The invention relates generally to DVD players, and more particularly to WebDVD players that allow existing legacy DVD discs to be linked to related web sites.

WebDVD, also known as Internet DVD, online DVD, enhanced navigation (ENav) DVD, etc., is a powerful concept of enhancing DVD-Video with Internet technology. WebDVD combines the best of DVD with the best of the Internet, so that they nicely complement each other and find applications in many areas. For example, a WebDVD movie can be connected to the Internet for promotional deals, viewer discussion forums, multiplayer games, etc. A marketing disc can entice viewers with gorgeous video products backed up by web pages for on-the-spot purchases. The possibilities are endless. WebDVD titles take advantage of the timeliness of the Internet with automatic software updates, supplemental content as new information becomes available, updated links to related web pages, current news and events, and special offers of associated services and products, etc. Thus, even after the WebDVD disc leaves the hands of the developers, it can still be improved or refreshed. What would otherwise be a static medium becomes dynamic and renewable, extending the life of the product.

The DVD Forum, an industrial consortium (http://www.dvdforum.org), is now defining a standard for web contents linked to WebDVD-Video discs. It allows DVD-Video discs to include built-in web links to web sites that contain contents related to the specific discs. The web sites may include new navigation menus for the player to download, so that the player can use them instead of the original DVD menus.

For existing legacy DVD-Video discs, however, it is not possible to have the enhanced contents provided on a web site and used in connection with the discs in the same way as for new WebDVD-Video discs. This would hinder and in fact prevent the high growth potentials of e-commerce activities in connection with playing the uncountable number of legacy discs by their owners.

Therefore, there is an urgent need to provide a WebDVD player that can locate a web site with contents related to an existing legacy DVD disc.

### SUMMARY OF THE INVENTION

The present invention provides a WebDVD player that can link legacy DVD discs to related web sites, in addition to playing normal WebDVD discs.

According to a first embodiment of the invention, the player includes a small database that contains a URL list of popular DVD content providers, e.g., AOL Time Warner, Walt Disney, etc. After the disc is loaded into the player, the player reads the provider unique identification (PVR_ID) from the disc and uses the PVR_ID to find the URL of the associated content provider from the URL list. The URL of the content provider is indexed to a table which contains a list of some popular title identifications (Title_IDs) of the discs produced by the content provider, location of the Title_ID on the disc, the method of deriving the Title_ID, and the URL of a related web site. The player then attempts to derive the Title_ID of the disc in accordance with the method specified in the table and compares the derived Title_ID with the data in the Title_ID column of the table to find the corresponding URL for locating the specific web pages of the content provider.

According to a second embodiment of the invention, a database similar to that in the player of the first embodiment is stored on a web server. This database has more comprehensive lists of the URL links to the web sites of the content providers and their video titles for accessing by the player. In the this embodiment, after the disc is loaded into the player, the player reads the PVR_ID and the Title_ID from the disc and links the disc to a source web site containing the database which may be provided by the player manufacturer or some other organization (e.g., DVD Forum) for searching a match.

A third embodiment of the invention combines the first and second embodiments. After the disc is loaded into the player, the player first refers to its internal database to find a matching Title_ID. If it cannot be found, the player will access the source web site to find the matching Title_ID.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 illustrates a connection between a WebDVD player to the Internet according to an embodiment of the invention;

FIG. 2 illustrates a detailed process of locating a related web site for a particular disc according to a first embodiment of the invention; and

FIG. 3 illustrates a detailed process of locating a related web site for a particular disc according to a second embodiment of the invention.

Throughout the drawings, the same reference numerals indicate similar or corresponding features or functions.

### DETAILED DESCRIPTION OF THE PREFERRED EMBODIMENTS

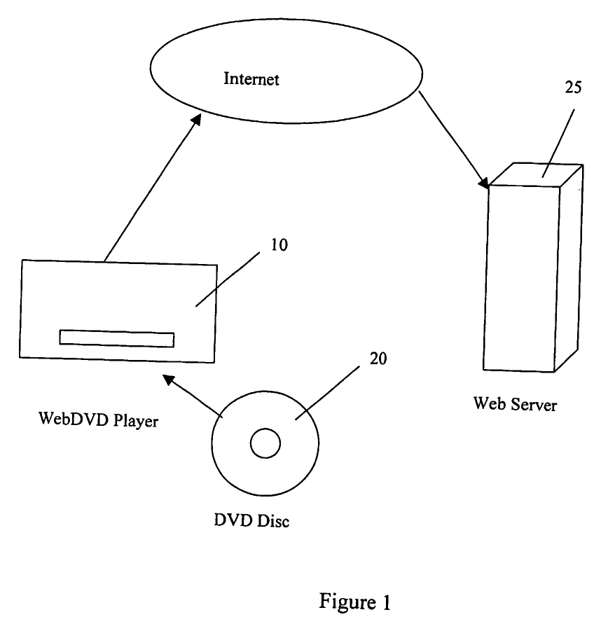

FIG. 1 illustrates a connection between a WebDVD player 10 to the Internet according to an embodiment of the invention. As illustrated, a DVD-Video disc 20 can be inserted into a WebDVD player 10 to interact with related web sites on a web server 25. Player 10 may also be implemented in other forms, e.g., a PC, etc. Disc 20 may be either a WebDVD-Video disc or an existing legacy DVD-Video disc. In order to link a legacy DVD-Video disc to a related web site, player 10 makes use of a PVR_ID (Provider Unique ID) of the disc that uniquely identifies the content provider of the disc and a title ID (Title_ID) of the disc that uniquely identifies a specific title of the disc (e.g., a movie).

A PVR_ID is present on every legacy DVD-Video disc and is located in a VMGI_MAT (Video Manager Information Management Table) data structure, as illustrated in Table 1.

TABLE 1
Partial Data Structure of VMGI_MAT

| Relative byte | | |
|---|---|---|
| position in | | Number |
| data structure | Contents | of bytes |
| 0 to 11 | VMG_ID (VMG Identifier) | 12 |
| . . . | . . . | . . . |
| 64 to 95 | PVR_ID (Provider unique ID) | 32 |
| . . . | . . . | . . . |

The VMGI_MAT contains control data for DVD video. The PVR_ID is described with 32 bytes using the character set code of IS0646. When PVR_ID is less than 32 bytes, 00h will be described in the unused area.

The Title_ID, however, is not defined in the DVD-Video standards, but can be made available in several ways. One way is to use a unique serial number located in the BCA (Burst Cutting Area) available in some legacy DVD-Video discs. Alternatively, the Volume Set ID in the UDF (Universal Disc Format) file system of the disc may be used as the Title_ID. Another way is to use a unique Title_ID stored by the content provider in a data sector of the disc that contains private data. There are a number of places in the data structure of the disc where the content provider can store their own information including the unique Title_ID. For example, the lead-in area for storing the content provider information may be used for such purpose. A third way is to use a generated Title_ID. In this approach, a statistically unique Title_ID is generated from certain information on the disc. For example, the information in VMGI_MAT may be used to generate the Title_ID of a disc, as will be described in detail later. Using this approach ensures the availability of the title IDs in all existing legacy discs.

In a first embodiment of the invention, player 10 includes a small database that contains a URL list of popular DVD content providers, e.g., AOL Time Warner, Walt Disney, etc. After disc 20 is loaded into player 10, the player reads the PVR_ID from the disc and uses the PVR_ID to find the URL of the associated content provider from the URL list. The URL is indexed to a table which contains a list of some popular Title_IDs produced by the content provider, location of the Title_ID on the disc, the method of deriving the Title_ID, and the corresponding URL of the related web site, as illustrated in Table 2. Player 10 then attempts to derive the Title_ID of the disc based on the data in the location and deriving method columns in the Table 2 and compares the derived Title_ID with the data in the Title_ID column to find the corresponding URL for locating the specific web pages.

TABLE 2
Exemplary Format of a Small Database in the Player

| | | Deriving | Algorithm | URL of Related |
|---|---|---|---|---|
| Title_ID | Location | Method | Type | Web Site |
| 0110101 . . . | BCA | Read | N/A | www.aoltw.com |
| . . . | . . . | . . . | . . . | . . . |
| 1011100 . . . | VMGI_MAT | Generate | Type 2 | www.disney.com |
| | | ID | | |
| . . . | . . . | . . . | . . . | . . . |

In Table 2, the location of the Title_ID may be in BCA, a data sector containing private data, VMGI_MAT, or other places in the data structure of the disc. The deriving method column specifies a method of deriving the Title_ID, e.g., read the Title_ID directly from a specific location of the disc or use a particular algorithm, as indicated in the algorithm type column, to generate the Title_ID. A list of algorithms corresponds to those algorithm types in Table 2 is pre-stored in the player, so that the player can use the indicated algorithm and the relevant data to compute and generate the Title_ID. The URL of related web site column indicates the corresponding URL. For example, if the location column indicates “BCA” and the deriving method column indicates “Read”, player 10 will try to read the BCA from the disc to find its Title_ID. However, not every DVD has BCA and also not every DVD player can read BCA. In this case, alternative method such as “Generate ID” may be used. In such case, player 10 will try to use the indicated algorithm to generate the Title_ID based on the information in the specified location (e.g., VMGI_MAT). There are many methods to generate the Title_ID. One way is to use a method similar to that in the CD-DB (CD Database) that links CDs to a service web site, utilizing the starting and ending addresses of the title sets or chapters to compute and generate the Title_ID. Another way is to use the information in the VMGI_MAT to generate the Title_ID. For example, the data in all fields of VMGI_MAT can be added together and the sum can be divided by a particular number to generate the Title_ID.

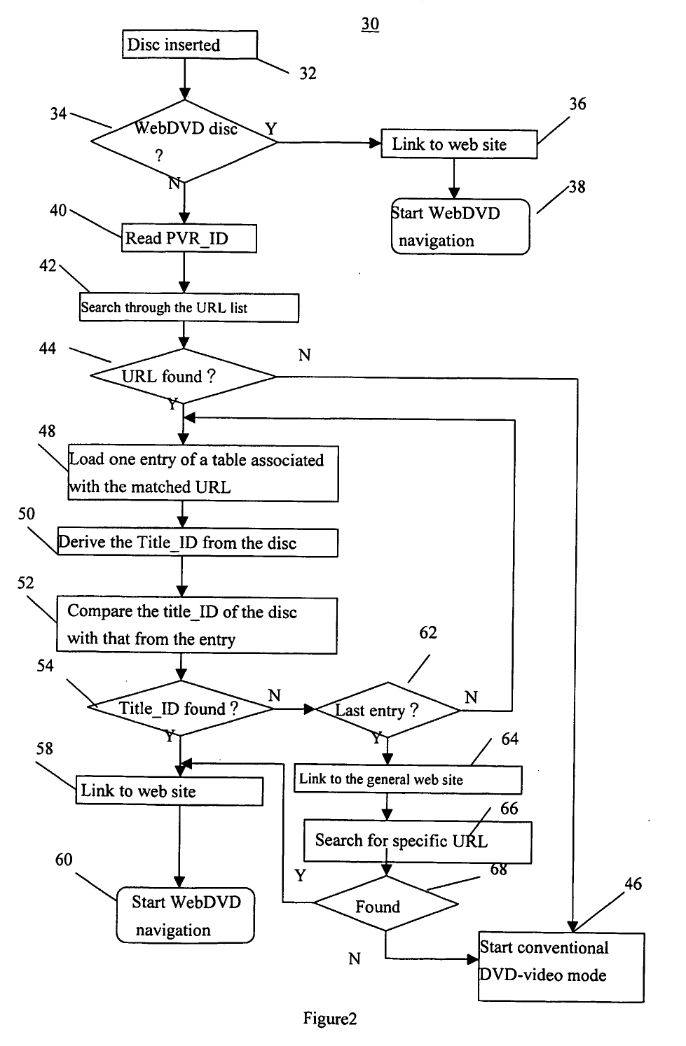

FIG. 2 illustrates a detailed process 30 of locating a related web site for a particular disc according to the first embodiment of the invention. After a disc is loaded into the player (step 32), the player detects whether the disc loaded is a WebDVD from the file system of the disc (step 34). If it is a WebDVD, the player links the disc to the related web site in accordance with the WebDVD standard adopted by the DVD Forum (step 36), and starts the WebDVD navigation (step 38).

On the other hand, if the disc is a legacy DVD, player 10 reads the PVR_ID from the disc to determine the associated content provider (step 40) and searches through the URL list in the database of the player (step 42) to find a corresponding URL of the content provider (step 44). If the URL is not in the list, player 10 will play the disc in a conventional manner by starting the conventional DVD-Video mode (step 46). If, however, the corresponding URL is found from the list, the URL is indexed to the table illustrated in Table 2. Then player 10 will load a first entry of the table that is associated with the URL into a memory of the player (step 48) and attempts to derive the Title_ID from the disc based on the information from the location, deriving method and algorithm type columns in that entry (step 50).

After the Title_ID of the disc is derived, it is compared with the data in the Title_ID column of the entry (step 52) to determine if there is a match (step 54). If there is a match, player 10 will retrieve the URL data in the URL column of the entry and use the URL data to link the disc to the corresponding web pages of the content provider (step 58) and start the WebDVD navigation (step 60). If, however, the derived Title_ID does not match the data in the Title_ID column of the entry, player 10 will determine whether the entry is the last one in the list (step 62). If so, the player will link the disc to the general web site of the content provider using the URL already found (step 64) and search for the specific URL for the disc in a similar manner as described above (step 66). The general web site would contain a table similar to Table 2. Whether the specific URL is found is next determined (step 68). If the specific URL is found, the player will link the disc to the specific URL (step 58) and start the WebDVD navigation (step 60). However, if it is not found, the player will play the disc in the conventional way (step 46).

In a variation of the first embodiment, if the player cannot find the PVR_ID from the disc, the player will simply load one entry of the table into the memory and attempt to derive the Title_ID of the disc based on the data in the location, deriving method and algorithm type columns. The player then determines whether the derived Title_ID matches with the data in the Title_ID column of the entry. The subsequent operations are the same as those in the first embodiment.

According to a second embodiment of the invention, a database similar to that in the player of the first embodiment is stored on a web server. This database has more comprehensive lists of the URL links to the web sites of the content providers and their video titles for accessing by the player. In the this embodiment, after disc 20 is loaded into player 10, the player reads the PVR_ID and the Title_ID from the disc and links the disc to a source web site containing the database which may be provided by the player manufacturer or some other organization (e.g., DVD Forum) for searching a match.

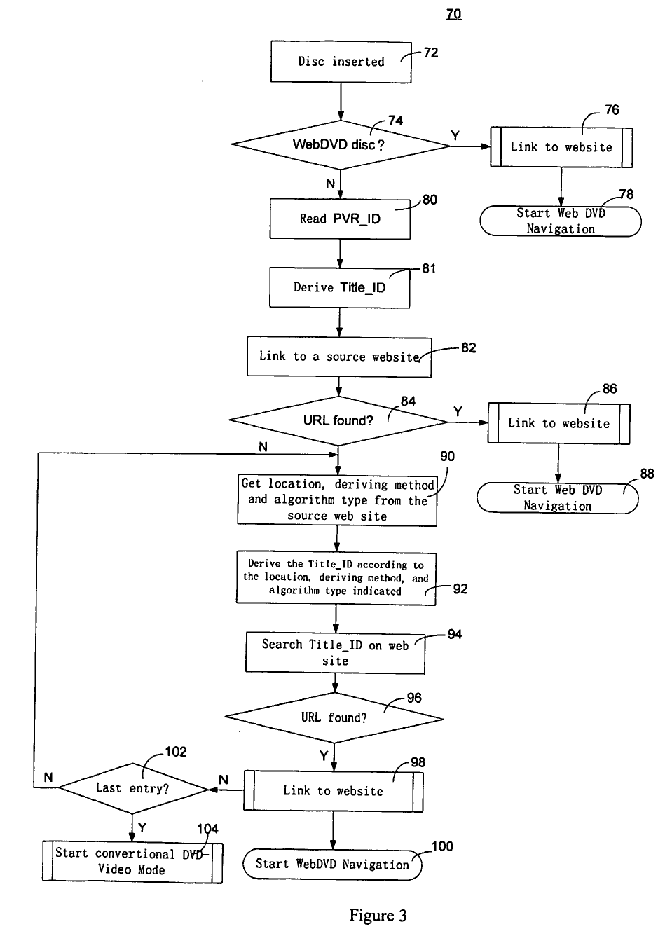

FIG. 3 illustrates a detailed process 70 of locating a related web site of a particular disc according to the second embodiment of the invention. After a disc is loaded into the player (step 72), the player detects whether the disc loaded is a WebDVD from the file system of the disc (step 74). If it is a WebDVD, the player links the disc to the related web site in accordance with the WebDVD standard adopted by the DVD Forum (step 76), and start the WebDVD navigation (step 78).

On the other hand, if the disc is a legacy DVD, player 10 reads the PVR_ID (step 80) and derives the Title_ID from the disc (step 81). The Title_ID is derived in a default manner, e.g., by reading a particular location on the disc, such as BCA. The player links the disc to the source web site (step 82) for searching the corresponding URL from the comprehensive database, based on the PVR_ID and Title_ID (step 84). If the URL is found, player 10 will link the disc to the corresponding web site (step 86) and start the WebDVD navigation (step 88). If the URL is not found, it could mean that the Title_ID derived in the default manner is incorrect. Then player 10 will obtain the information about the location, deriving method of the Title_ID and algorithm type from a first entry in a table on the web site that is similar to Table 2 (step 90).

The player then attempts to derive the Title_ID of the disc according to the location, deriving method and algorithm type indicated by the first entry of the table (step 92). After deriving the Title_ID of the disc, player 10 will use the PVR_ID and Title_ID just derived to search for a corresponding URL from the database on the web site (step 94) to determine if a match is found (step 96). If the URL is found, player 10 will link the disc to the corresponding web site (step 98), and start the WebDVD navigation (step 100). However, if the URL is not found, a determination of whether the entry is the last one in the table is made (step 102). If it is, it means that the disc is not supported by the web site and player 10 will play the disc in a conventional manner by starting the conventional DVD-Video mode (step 104). If it is not, steps 90, 92, 94 and 96 will be repeated, along with steps 98 and 100 if applicable until either a match is found or all entries in the list have been examined.

A third embodiment of the invention combines the first and second embodiments of the invention as described above. In the third embodiment, the player contains a list of the popular content providers in a small database to allow a preliminary search of a corresponding URL. If after searching through this database no match is found, the source web site will be accessed by the player for conducting a more comprehensive search. The flowchart diagram for the third embodiment of the invention is based on that in FIG. 2, except that if the URL is not found at step 44, steps 81 through 104 in FIG. 3 will be implemented.

In the third embodiment above, the database in the player may be periodically updated with new information from the source web site. Also, the player may cache the addresses of the specific web sites once they are accessed and delete old addresses not recently accessed so that when the disc is played next time, the contents will be loaded faster. Further, users may even manually update the database with new web site addresses.

In the above, DVD-Video discs have been described in connection with the invention. The same principles of the invention can be applied to other types of discs, e.g., DVD-Audio discs and Super Audio CDs (SACDs).

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A WebDVD player, comprising:
means for deriving a title identification (Title_ID) of a legacy DVD disc, the Title_ID being a unique identifier of a title of the disc; and
means for linking the disc to a related web site based on the derived Title_ID.

2. The player of claim 1, wherein the Title_ID is derived in accordance with a method specified in a database.

3. The player of claim 2, further comprising means for determining whether the derived Title_ID matches an expected value indicated in the database that is associated with the specified method.

4. The player of claim 2, further comprising means for retrieving a universal resource locator (URL) in the database that is associated with the expected value if the derived Title_ID matches the expected value.

5. The player of claim 2, wherein the Title_ID is derived by retrieving a unique identifier from a pre-selected location of the disc.

6. The player of claim 5, wherein the pre-selected location is a burst cutting area (BCA).

7. The player of claim 5, wherein the pre-selected location is a private data sector.

8. The player of claim 1, wherein the Title_ID is a Volumn Set ID in a Universal Disc Format (UDF) file system of the disc.

9. The player of claim 2, wherein the Title_ID is derived based on selected data available on the disc.

10. The player of claim 1, further comprising:
means for retrieving a provider unique identification (PVR_ID) from the disc;
wherein the Title_ID is derived based on the retrieved PVR_ID of the disc.

11. The player of claim 10, further comprising:
means for storing a database containing a list of universal resource locators (URLs) for linking to web sites of preselected content providers, and a table of expected Title_IDs associated with the individual URLs;
means for determining whether the retrieved PVR_ID matches a corresponding URL in the list; and
means for searching through the Title_IDs in the table that are associated with the corresponding URL for finding a matching Title_ID.

12. The player of claim 11,
wherein the database further includes a list of methods for deriving the Title_ID of a disc, the expected Title_IDs being respectively associated with the methods and derivable in accordance with the respective methods;
wherein the Title_ID is derived in accordance with a method specified in the table;
wherein the searching means determines whether the derived Title_ID matches an expected Title_ID in the table.

13. The player of claim 12, wherein if the derived Title_ID fails to match any expected Title_ID in the table, the linking means links the disc to a general web site of a content provider using the corresponding URL.

14. The player of claim 12, further comprising:
means for accessing a source web site, if the derived Title_ID does not match any expected Title_ID in the table, the source web site containing a database which includes a list of universal resource locator (URL) links to related web sites and their associated PVR_IDs and Title_IDs;
means for searching a corresponding URL in the database based on the retrieved PVR_ID and derived Title_ID; and
means for linking the disc to a related web site using the corresponding matching URL.

15. The player of claim 12, wherein the Title_ID is derived based on selected data available on the disc.

16. A WebDVD player, comprising:
means for retrieving a provider unique identification (PVR_ID) from a legacy DVD disc;
means for deriving a title identification (Title_ID) from the disc in a default manner, the Title_ID being a unique identifier of a title of the disc;
means for accessing a source web site containing a database which includes a list of universal resource locator (URL) links to related web sites and their associated PVR_IDs and Title_IDs;
means for searching a corresponding URL in the database based on the retrieved PVR_ID and derived Title_ID; and
means for linking the disc to a related web site using the corresponding matching URL.

17. The player of claim 16, wherein the database further includes a list of methods for deriving the Title_ID of a disc, the methods being associated with the Title_IDs which are derivable in accordance with the respective methods.

18. The player of claim 17, further comprising:
means for deriving the Title_ID of the disc in accordance with a method specified in the database, if the corresponding URL cannot be found by the searching means; and
means for determining whether the derived Title_ID matches a Title_ID indicated in the database that is associated with the specified method;
wherein the searching means searches an associated URL in the database based on the retrieved PVR_ID and the matching Title_ID;
wherein the linking means links the disc to a related web site using the associated URL.

19. The player of claim 18, wherein the method specified indicates retrieving a unique identifier from a pre-selected location of the disc.

20. The player of claim 18, wherein the Title_ID is derived based on selected data available on the disc.

21. A method for linking a legacy DVD disc to a related web site, the method comprising the steps of:
deriving a title identification (Title_ID) of the disc, the Title_ID being a unique identifier of a title of the disc; and
linking the disc to a related web site based on the derived Title_ID.

22. The method of claim 21, wherein the Title_ID is derived in accordance with a method specified in a database.

23. The method of claim 22, further comprising the step of determining whether the derived Title_ID matches an expected value indicated in the database that is associated with the specified method.

24. The method of claim 22, further comprising the step of retrieving a universal resource locator (URL) in the database that is associated with the expected value if the derived Title_ID matches the expected value.

25. The method of claim 22, wherein the Title_ID is derived by retrieving a unique identifier from a pre-selected location of the disc.

26. The method of claim 25, wherein the pre-selected location is a burst cutting area (BCA).

27. The method of claim 25, wherein the pre-selected location is a private data sector.

28. The method of claim 21, wherein the Title_ID is a Volumn Set ID in a Universal Disc File (UDF) file system of the disc.

29. The method of claim 21, wherein the Title_ID is derived based on selected data available on the disc.

30. The method of claim 29, further comprising the steps of:
retrieving a provider unique identification (PVR_ID) from the disc;
wherein the Title_ID is derived based on the retrieved PVR_ID of the disc.

31. The method of claim 30, further comprising the steps of:
pre-storing a database containing a list of universal resource locators (URLs) for linking to web sites of pre-selected content providers, and a table of expected Title_IDs associated with the individual URLs;
determining whether the retrieved PVR_ID matches a corresponding URL in the list; and
searching through the Title_IDs in the table that are associated with the corresponding URL for finding a matching Title_ID.

32. The method of claim 30,
wherein the database further includes a list of methods for deriving the Title_ID of a disc, the expected Title_IDs being respectively associated with the methods and derivable in accordance with the respective methods;
wherein the Title_ID is derived in accordance with a method specified in the table;
wherein the searching step includes a step of determining whether the derived Title_ID matches an expected Title_ID in the table.

33. The method of claim 32, further comprising the steps of:
accessing a source web site, if the derived Title_ID does not match any expected Title_ID in the table, the source web site containing a database which includes a list of universal resource locator (URL) links to related web sites and their associated PVR_IDs and Title_IDs;
searching a corresponding URL in the database based on the retrieved PVR_ID and derived Title_ID; and
linking the disc to a related web site using the corresponding matching URL.

34. A method for linking a legacy DVD disc to a related web site, the method comprising the steps of:
retrieving a provider unique identification (PVR_ID) from a legacy DVD disc;
deriving a title identification (Title_ID) from the disc in a default manner, the Title_ID being a unique identifier of a title of the disc;
accessing a source web site containing a database which includes a list of universal resource locator (URL) links to related web sites and their associated PVR_IDs and Title_IDs;
searching a corresponding URL in the database based on the retrieved PVR_ID and derived Title_ID; and
linking the disc to a related web site using the corresponding matching URL.

35. The method of claim 34, wherein the database further includes a list of methods for deriving the Title_ID of a disc, the methods being associated with the Title_IDs which are derivable in accordance with the respective methods.

36. The method of claim 35, further comprising the steps of:
deriving the Title_ID of the disc in accordance with a method specified in the database, if the corresponding URL cannot be found; and
determining whether the derived Title_ID matches a Title_ID indicated in the database that is associated with the specified method;
wherein the searching step searches an associated URL in the database based on the retrieved PVR_ID and the matching Title_ID;
wherein the linking step links the disc to a related web site using the associated URL.

37. The method of claim 36, wherein the Title_ID is derived based on selected data available on the disc.

38. The player of claim 14, further comprising means for periodically updating the database and the table stored by the storing means with information from the source web site.

39. The player of claim 14, further comprising means for caching an address of a website address each time the web site is accessed.

40. The player of claim 14, further comprising means for allowing a user to manually update the database and the table stored by the storing means with new information.
